(19) United States
(12) Patent Application Publication
(10) Pub. No.: US 2024/0242335 A1
(43) Pub. Date: Jul. 18, 2024

(54) PROCESS USED TO SHAPE ITEMS OF EQUIPMENT COMPRISING A BLADE

(71) Applicants: LISI AEROSPACE, Paris (FR); LISI AEROSPACE FORGED INTEGRATED SOLUTION, Bologne (FR)

(72) Inventors: Loïc MEIFFRE, Conflans Sainte Honorine (FR); Thomas BAIZEAU, Chaumont (FR); Sagar APSHANKAR, Paris (FR)

(73) Assignees: LISI AEROSPACE, Paris (FR); LISI AEROSPACE FORGED INTEGRATED SOLUTIONS, Bologne (FR)

(21) Appl. No.: 18/407,079

(22) Filed: Jan. 8, 2024

(30) Foreign Application Priority Data
Jan. 12, 2023 (FR) FR2300320

(51) Int. Cl. G06T 7/00; B21D 53/78

(52) U.S. Cl. CPC G06T 7/001; B21D 53/78; G06T 2207/20081; G06T 2207/30164

(57) ABSTRACT

A process for shaping a part (12) of the turbine vane type, includes providing a part (12) comprising a blade (14) in an initial shape, providing a nominal definition representing the part in a nominal shape, comparing the initial shape with the nominal definition to determine compliance or non-compliance, for a non-compliant datum, determining a force to be applied to the part to deform said part, applying a force to obtain the part in a deformed shape, comparing the deformed shape with the nominal definition to determine compliance or non-compliance, and training a self-learning algorithm (82).

### BACKGROUND

The present invention describes a process used to shape parts of equipment comprising a blade. The invention is specifically applicable to turbine or compressor vanes, static (variable or non-variable) or rotor type, comprising a blade.

A vane blade typically has the shape of a twisted wing, the aerodynamic profile of which is designed to optimize fluid flow and compress it.

Conventional vane manufacturing processes such as machining, forging or extrusion do not always produce the required twist or deflection. Blades are therefore frequently subjected to a straightening process designed to adjust the shape of the blade to fall within the tolerance intervals around the nominal profile. This process is described in document EP1494003.

### SUMMARY

The aim of the present invention is to provide a process for automating blade straightening, and for continuously improving the result by means of machine learning.

The invention therefore provides a shaping process of the type described above, comprising the following steps:
provision of a part comprising a blade in an initial shape, said blade extending along an axis, and comprising at least one first gripping area located at one axial end of the blade;
provision of a nominal definition representing the part in a nominal shape, said nominal definition comprising a set of nominal dimensions and associated tolerances;
three-dimensional acquisition of a first set of data representing the part in the initial shape;
comparison of the first set of data with the nominal definition, to determine the compliance or non-compliance of at least one data item in the first data set;
for non-compliant data, determination by a self-learning algorithm, trained on a plurality of parts of the same type, of the appropriate force to apply to said part at a sufficient probability so that the non-compliant data at least is subsequently determined to be compliant;
application of the force determined in the previous step to the part to obtain a deformed shape,
three-dimensional acquisition of a second data set representing the part in the deformed shape;
comparison of the second data set with the nominal definition in order to determine the conformity or non-conformity of one or more data items in the second data set;
measurement and recording of the parameters of the first force applied, of the first and second data sets and of the compliance and non-compliance characteristics determined in the comparison steps; and
training the self-learning algorithm based on the measurements and recordings taken in the previous step.

Among other advantageous aspects of the invention, the process comprises one or more of the following features, taken individually or in accordance with all technically possible combinations:
the force is chosen between: a bending force, perpendicular to the blade axis; a torsional force about said blade axis; and a combined bending and torsional force;
at least one three-dimensional acquisition is performed using contact or non-contact measuring equipment;
each of the nominal definition, the first and the second set of data comprises at least one data item from among: a set of dimensions of a section of the blade, a twist angle, a thickness of a leading edge of the blade, a thickness of a trailing edge of the blade, a position of a key point on an outer surface of the part, or a combination of any of these data items;
during the application of force to the blade, a grip is exerted on at least the first gripping area;
during the application of force to the blade, a second gripping area of the part is held stationary relative to a frame;
the force is a bending force, perpendicular to the axis of the blade; said bending force being applied by exerting pressure on a bearing area of the blade, said bearing area being located between the first and second gripping areas of said part;
the force is a torsional force applied around the axis of the blade; one of the gripping elements and the second portion of the part is held stationary relative to a frame; and the torsional force is applied by rotating, relative to the frame, the other of said first and second gripping areas;
the force is a torsional force applied around the axis of the blade; and the torsional force is applied by rotating the first and second gripping areas relative to each other;
the part further comprises an identifier, the process additionally comprising the following steps: reading the identifier; determining the nominal definition corresponding to the part from among a plurality of nominal definitions; and identifying the self-learning algorithm corresponding to the part from among a plurality of self-learning algorithms.

The invention also relates to an assembly for implementing a process according to one of the preceding claims, comprising: a measuring device, capable of acquiring three-dimensional data of the part, in the initial shape and/or in the deformed shape; a system capable of applying force to the part; and an electronic device comprising a data memory and at least one self-learning algorithm trained on a plurality of parts of the same type as the part, said measuring device, system and electronic device being connected by at least one communication channel.

### BRIEF DESCRIPTION OF THE DRAWINGS

The invention will be better understood upon reading the following description, which is presented only as a non-limiting example, and with reference to the drawings, in which:

FIG. 1 is a schematic view, from above, of a system and assembly for implementing a shaping process according to one embodiment of the invention;

FIGS. 2 and 3 are partial schematic views of the system shown in FIG. 1;

FIG. 4 is a flow chart of a shaping process according to one embodiment of the invention; and

FIG. 5 is a learning process flow chart representing a shaping process according to one embodiment of the invention.

### DETAILED DESCRIPTION

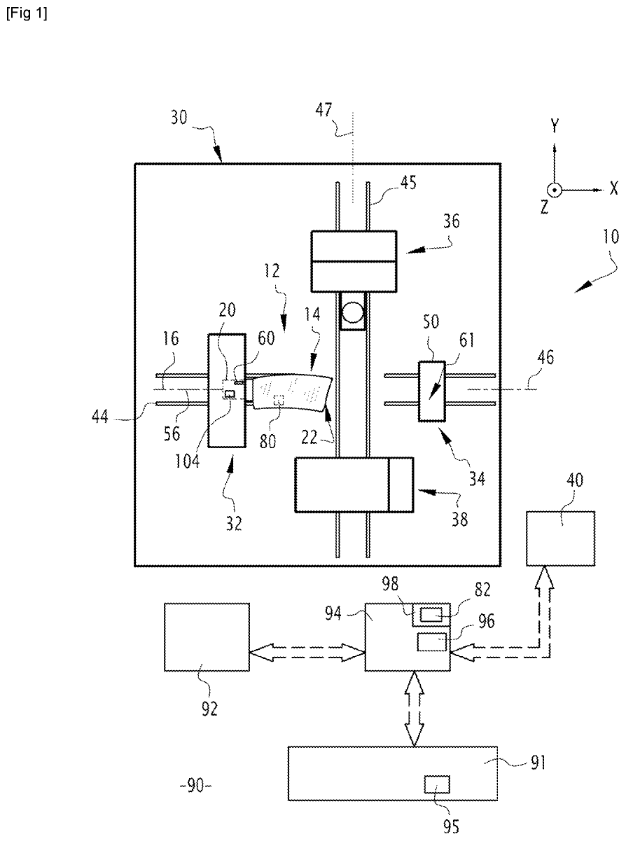

FIG. 1 shows the installation 10 for implementing a manufacturing process for a part 12 of equipment.

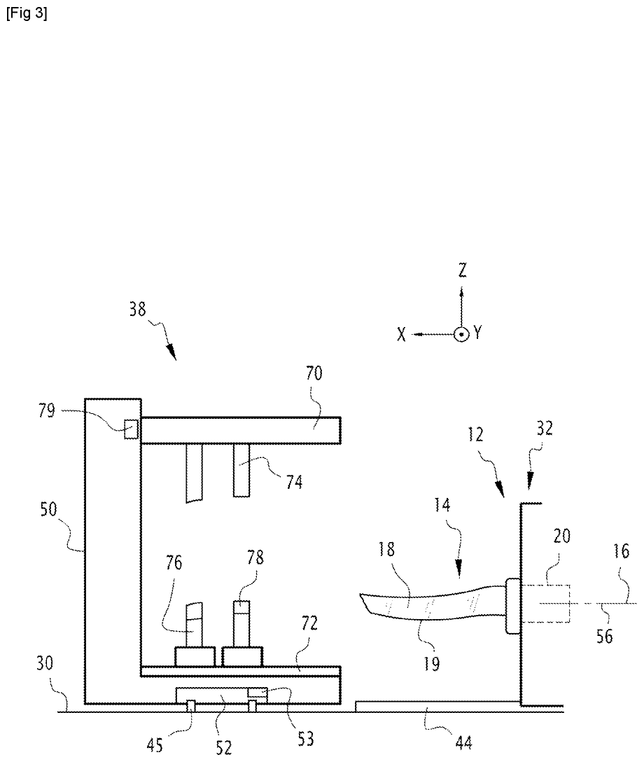

Part 12, shown in FIGS. 1 and 3, is a turbine or compressor type vane. In particular, the part 12 comprises a metallic blade 14, extending along a main axis 16.

The blade 14 has a curved surface. In particular, the blade 14 comprises two opposite curved faces 18, 19, each of said faces extending substantially along the axis 16.

In the embodiment shown, the part 12 also comprises a first gripping area 20, located at a first axial end of the blade 14, in the form of a vane root. The root 20 and the blade 14 are formed as a one-piece unit from a metallic material such as an iron, titanium, aluminum, copper, or nickel base alloy, or from a plastic material, or are formed as a composite from a metallic material and a plastic material.

In a variant not shown, the part 12 also comprises an edge, located at a second axial end 22 of the blade 14, opposite the root 20.

The installation 10 is designed to perform a straightening operation on the blade 14 of the part 12 to give it the desired final shape, in the event of too great a discrepancy between this desired shape—compliant with a definition of the vane—and the shape of the actual blade resulting from standard manufacturing processes, e.g. forging, extrusion or machining.

The installation 10 comprises a fixed frame 30 and at least two mobile units 32, 34, 36, 38, capable of exerting a force on the blade 14 to deform it. In the embodiment shown, the moving units comprise: a gripping unit 32; a supporting unit 34; a bending unit 36; and a torsion unit 38.

The installation 10 also comprises an electronic module 40, which includes a microprocessor. The electronic module 40 also preferably includes: a module for converting analog data—from the sensors—into digital data; an algorithm for pre-processing the data, to remove outliers and standardize the digital data for further processing by a program; and possibly a display or sound transmitter.

Consider an orthonormal base (X, Y, Z) associated with frame 30, with direction Z representing the vertical.

The frame 30 comprises: an upper surface extending in a plane (X, Y); and guiding devices 44, 45 for the gripping, supporting, bending and torsion units on said upper surface.

The guiding devices 44, 45 are, for example, rails. In the embodiment shown, the first rails 44 are positioned along the first axis 46 parallel to X, and the second rails 45 are positioned along a second axis 47 parallel to Y.

Each of the gripping, supporting, bending and torsion units comprises: a structure 50; and a device 52 for the motorized displacement of said structure, along at least one of the guiding devices 44, 45 of the frame 30.

More specifically, in the embodiment shown, the structures 50 of the gripping unit 32 and the support unit 34 can move along X, along the first rails 44; and the structures 50 of the bending unit 36 and the torsion unit 38 can move along Y, along the second rails 45. In a variant not shown, at least one mobile unit of the installation 10 can move in two directions in a plane (X, Y).

Preferably, the motorized displacement devices 52 are controlled by the electronic module 40; and each of the devices 52 is coupled to a sensor 53 for detecting the position of the corresponding device on the frame 30. Each position sensor 53 is connected to the electronic module 40. The connections between the electronic module 40 and the displacement devices 52 and each sensor 53 are preferably by wire.

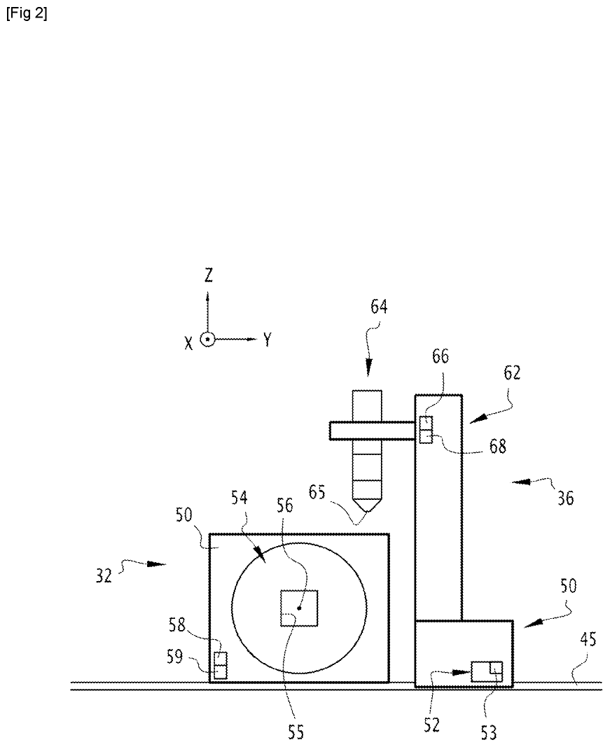

The gripping unit 32, shown in FIG. 2, will now be described. In addition to its structure 50, the gripping unit 32 includes a torsion gripping element 54.

The element 54 can exert a grip on the part 12, in particular on the root 20, so as to keep said root fixed relative to said element 54. The element 54 comprises a housing 55 (FIG. 2), suitable for receiving and holding the root 20.

In addition, the element 54 is capable of rotating relative to the structure 50 of the unit 32, along a third axis 56 parallel to X. The housing 55 preferably extends along the third axis 56.

More specifically, in cooperation with the torsion unit 38, the rotating element 54 can apply a torsional force to the part 12, as will be detailed below.

The gripping unit 32 also comprises: a sensor 58 for the angular position of the element 54 relative to the structure 50; and a sensor 59 for the torque exerted by an angular displacement of said element relative to said structure, the torque can be applied to the part in both clockwise and anti-clockwise directions.

In one embodiment, the gripping unit 32 comprises a device for detecting a marker 60 (FIG. 1) located on the part 12, for example on the root 20. Thus, when the part 12 is assembled in the housing 55, an angular position of said part 12 is associated with the angular position of the element 54, detected by the sensor 58.

Preferably, the element 54 and the sensors 58, 59 are connected to the electronic module 40 by a wire connection.

The support unit 34 comprises an upper surface 61. Said upper surface is capable of being positioned under a second gripping area of the part 12.

Preferably, the upper surface 61 of the support unit 34 has a shape capable of coming into contact with said second gripping area of the part 12. The second gripping area can be formed by the root, or a blade portion at an axial distance from the root and the edge.

More precisely, in the embodiment shown, the upper surface 61 of the unit 34 has a shape capable of coming into contact with the edge, and preferably has a shape complementary to that of the edge.

Optionally, the support unit 34 also includes devices (not shown) for adjusting the height along Z of the upper surface 61 relative to its structure 50. These devices are connected to the electronic module 40.

The bending unit 36, shown in FIG. 2, will now be described. In addition to its structure 50, the bending unit 36 includes a press 62. In particular, the press 62 comprises an application head 64, movable along Z relative to the structure 50 of the bending unit 36. The application head 64 can exert a vertical downward force on the part 12, more precisely on a specific area of the blade 14, as will be described below. One end of the head 64 has a bearing surface 65, designed to come into contact with the blade 14 or the root.

The bending unit 36 also comprises: a sensor 66 for the travel of the head 64 along Z; and a sensor 68 for the force exerted by or on said head.

Preferably, the press 62 and the sensors 66, 68 are connected to the electronics module 40 by wire.

The torsion unit 38, shown in FIG. 3, will now be described. In addition to its structure 50, the torsion unit 38 comprises an upper flange 70 and a lower flange 72. At least one of the upper 70 and lower 72 flanges are movable along Z relative to the structure 50 of the unit 38. Optionally, each of the upper 70 and lower 72 flanges are movable along Z relative to said structure 50.

In one embodiment, at least one of the upper 70 and lower 72 flanges are also movable along the X axis relative to the structure 50.

Each of the upper 70 and lower 72 flanges have at least one pin 74, 76. The upper 70 and lower 72 flanges are configured to grip the second gripping area 22 of the part 12 between the pins 74, 76. Preferably, the end of each pin 74, 76 has a surface 78 configured for contact with the second gripping area. In an embodiment not shown, surfaces 78 are configured for contact with the edge.

In the embodiment shown, each of the upper 70 and lower 72 flanges have two pins 74, 76, each pin 74 of the upper flange being vertically aligned with a pin 76 of the lower flange.

Preferably, the torsion unit 38 also includes a sensor 79 for the force exerted by or on the upper flange and/or the lower flange.

Preferably, the upper flange 70 and/or the lower flange 72 and/or the sensor 79 are connected to the electronic module 40 by wire.

The first step in the process for shaping the part 12 will now be described. This first step, known as the deflection operation, is carried out as follows:

Initially, it is assumed that the root 20 is assembled to the housing 55 of the element 54 of the gripping unit 32, so that the axis 16 of the part and the third axis 56 of rotation of the element 54 coincide, as shown in FIGS. 1 and 3.

Firstly, a bearing area 80 on the blade 14 is determined by a self-learning algorithm 82. Said algorithm 82 is stored in the electronic module 40, or in a control device 94, as will be described subsequently.

The bearing area 80, for example, has similar dimensions to the support surface 65 of the application head 64 of the bending unit 36.

Based on the location of the bearing area 80 on the blade 14, the algorithm 82 determines: an angular position of the element 54 relative to the corresponding structure of the gripping unit 32; a position along X of said gripping unit 32; and a position along Y of the bending unit 36. These positions are configured to enable the applicator head 64 to come into contact with the support area 80 during a downward vertical movement of said head.

Algorithm 82 also determines a position along X of the support unit 34, so that the upper surface 61 is in contact with the part 12 during the vertical movement of the applicator head 64. In particular, the position of the support unit 34 is chosen so that, during its vertical movement, the head 64 is positioned along X between the gripping unit 32 and the support unit 34.

Based on the positions determined above, the displacement devices 52 are actuated by the electronic module 40 to position the gripping unit 32, the support unit 34 and the bending unit 36 in the corresponding positions on the frame 30; and the element 54 is placed in the corresponding angular position.

The press 62 is then actuated by the electronic module 40 to move the applicator head 64 downwards. The bearing surface 65 thus comes into contact with the bearing area 80. The downward movement of the head 64 is continued to apply a force to the support area 80. The part 12, axially supported on either side of said support area, undergoes a first bending deformation, known as deflection, perpendicular to the main axis 16.

The travel of head 64 from the moment of contact with the part 12 is detected by the travel sensor 66 and the force sensor, to detect contact. Similarly, the force exerted between the head 64 and the part 12 is detected by the force sensor 68.

When a desired travel and/or force, determined by the algorithm 82, is reached, the downward movement of the head 64 is stopped. The position of the support area 80 and the travel and force measurements are stored in a data memory 96 which will be described subsequently. The head 64 is moved upwards to release the part 12.

A second step in the process for shaping the part 12 will now be described. This second step, known as the untwisting operation, is carried out as follows:

As in the deflection operation described above, it is initially assumed that the root 20 is assembled to the housing 55 of the element 54, so that axes 16 and 56 coincide.

Firstly, the algorithm 82 determines an area or areas of the part 12 intended to come into contact with the pins 74, 76 and said positions are determined accordingly. The algorithm 82 thus determines: an initial angular position of the element 54 relative to the corresponding structure of the gripping unit 32; a position along X of said gripping unit 32; a position along Y of the torsion unit 38; and a position along Z of upper flange 70 and/or lower flange 72 of said torsion unit, relative to the corresponding structure. The said positions are configured so that a third gripping area for the part 12 is held between the upper and lower flanges, as described above. The third gripping area can be any section of the blade, or the edge.

Based on the positions determined above, the displacement devices 52 are actuated by the electronic module 40 to position the gripping and torsion units 32 and 38 at the corresponding locations on the frame 30; the element 54 is moved to the corresponding initial angular position; then the upper flange 70 and/or the lower flange 72 is/are displaced along Z so as to grip the third gripping area.

Preferably, the force exerted by the flanges 70, 72 on the part 12 is controlled by the installation 10, particularly at the end of the travel.

The rotational gripping element 54 is then rotated about the third axis 56 relative to the structure 50 of the gripping unit 32. The blade 14 undergoes a torsional force and consequently a second deformation, referred to as untwisting. The angular displacement of the element 54 is measured by the angular position sensor 58; and the torque exerted by the element 54, as well as its clockwise or counter-clockwise direction, are measured by the torque sensor 59.

When a desired angular displacement and/or torque, determined by the program 82, is reached, the angular displacement of the element 54 is stopped at a final angular position. The angular displacement and torque measurements are stored in the data memory 96.

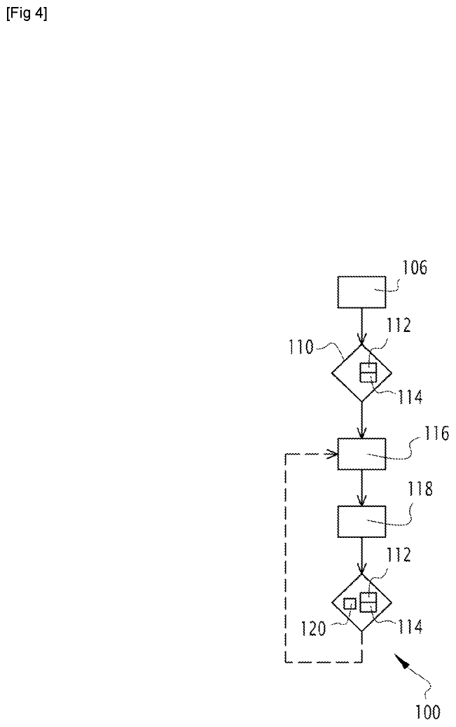

The deflection and untwisting operations described above are implemented in the process 100 for shaping the parts 12 as described above. The process 100 is shown as a flow chart in FIG. 4.

To implement the process 100, the installation 10 described above is incorporated into an assembly 90, in which the said installation 10 is associated with the following elements, shown schematically in FIG. 1: an imaging device 91; an automaton 92; and a control device 94.

The imaging device 91 can acquire data representative of the part 12 in three dimensions, and in particular of the blade 14. The imaging device 91 includes a reader 95 for two-dimensional traceability and identification data.

The imaging device 91 is, for example, a contact measuring machine, such as a coordinate measuring machine (CMM) or a multi-dimensional measuring bench. Alternatively, the imaging device 91 can be a non-contact measuring device such as a three-dimensional scanner, or a one- or two-dimensional scanner, used in several directions relative to the part.

The automaton 92, for example a robot arm, can move the part 12 between the imaging device 91 and the installation 10, as well as assembling and/or disassembling said part 12 and the housing 55 of the gripping unit 32.

The controller device 94 comprises a data memory 96 and a program memory 98. The program memory 98 contains as many self-learning algorithms as vane definitions. Alternatively, the program memory 98 includes a self-learning algorithm 82 and a set of parameters for each part 12 definition. The control device 94 can be implemented as a computer, embedded system, or automaton, said computer, system or automaton comprising a data memory 96 and a program memory 98. Alternatively, the controller 94 can be implemented in a separate form, in which the data memory 96 is stored on a remote server and the program memory 98 is stored in a computer, embedded system, or automaton, or vice versa, or in a fully remote form, in which the database and program memory 98 are each stored on a server or in a cloud.

The control device 94 is connected to the electronic module 40 of the installation 10, to the imaging device 91 and to the automaton 92.

Preferably, the imaging device 91, the automaton 92 and the electronics module 40 each communicate with the control device 94 via a wireless link. In this way, the control device 94 can be remote from the assembly 90, either in a server room or in the cloud. When the control device 94 is a computer or automaton, the imaging device 91, the automaton 92 and the electronic module 40 each communicate with the control device 94, preferably via a wired link.

The process 100 for shaping the parts 12 will now be described. The said process 100 is implemented by the self-learning algorithm 82 of the control device 94.

A production batch is supplied, consisting of the parts 12 in an initial state. Said parts 12 are substantially identical to one another and are obtained, for example, by forging.

Each part 12 of said production batch has an identifier, notably a visual identifier 104 such as a serial number, a one- or two-dimensional barcode, an RFID device, or a combination of two or all three types of identifiers. The visual identifier is used to link each part 12 of a production batch to a nominal definition 112. A nominal definition is defined by a material, a definition drawing defined by a set of nominal dimensions, and a set of associated tolerances, defining, for example, the minimum and maximum permissible dimensions in the three dimensions of the vane. The nominal definition 112 can, for example, be described using discrete information representative of the geometry of part 12, such as a set of dimensions in an orthonormal base (X, Y, Z) of a section of the blade, for example, defined at an axial distance from a surface of the root 20, a twist angle about axis 16, for example defined at an axial distance from a surface of root 20, a thickness of a leading edge of the blade, a thickness of a trailing edge of the blade, a position of one or more particular points on an outer surface of the blade, or a combination of any of these data.

The visual identifier 104 also enables each part 12 to be linked to a self-learning algorithm 82, as will be described subsequently.

Each part 12 of the production batch undergoes the following steps:

Firstly, an initial first three-dimensional acquisition 106 of the part 12, in particular of the blade 14, is performed by the imaging device 91. The initial three-dimensional acquisition generates a first set of data 114 representative of the geometry of the part 12 in its initial shape.

According to an embodiment, this first data set 114 comprises at least the same information as that of the nominal definition 112, or only part of said information.

In one embodiment, the imaging device 91 scans the identifier 104 of the part 12. The identifier 104 is sent to the controller 94, which compares the identifier to a set of nominal definitions stored in the data memory 96.

The comparison identifies the nominal definition 112 and its definition characteristics, corresponding to the manufactured part 12. The comparison also identifies the self-learning algorithm 82 to be used, said algorithm being associated with the nominal definition of the part 12.

This is followed by a comparison (step 110) of each item of data in the first data set 114 with the corresponding data in the nominal definition 112 of part 12. The identifier of the part 12, said first data set 114 and the compliance or non-compliance of each data item in the first data set 114 are stored in the data memory 96.

The comparison determines whether the identified part 12, in its initial state, conforms to the blade's nominal profile.

If at least one data in the first data set 114 does not conform to the corresponding data in the nominal definition 112, for example a twist angle measured at a particular distance along the axis is greater than the maximum permissible definition angle at that same distance, the algorithm 82 performs the following operations (step 116):
determination of the deformation/straightening operation best suited to deforming the part to the desired profile, between the deflection and untwisting operations; then,
if the deflection operation is chosen, determination of the position of the support area 80, and of the force or travel to be applied to the part 12 to obtain the desired deformation; or
if the untwisting operation is chosen, determination of the angular displacement or torque to be applied to the part 12 to obtain the desired deformation.

Then (step 118), the automaton 92 places the part 12 in the housing 55 of the installation 10; and the operation defined in the previous step by the algorithm 82 is carried out by said installation 10, as described above.

In the embodiment under consideration, the information on the bearing area 80, determined by the algorithm 82, is transmitted to the electronic module 40 of the installation 10.

Then, the controller 92 transfers the part 12 to the imaging device 91; and a second three-dimensional acquisition of the part 12 in a deformed state, in particular of the blade 14, is performed, so as to generate a second set of data 120 representative of the geometry of the blade 14 in the deformed shape.

The second data set 120 is compared with the nominal definition 112 to determine whether the identified part 12, in the deformed state, conforms.

The position, angle, travel, torque and/or force values measured by the sensors 53, 58, 59, 66, 68, 79 during the deflection and/or untwisting operation, as well as the compliance and non-compliance characteristics of the second data set, are stored in the data memory 96 of the control device 94, together with the part identifier 12.

By means of a machine learning process, these values are considered in the self-learning algorithm 82, corresponding to step 116 described above, to determine the optimum deformation/straightening operation to be implemented on each subsequent part 12 of the batch concerned, and for each part 12 of each batch manufactured according to the definition drawing of the same nominal part.

According to an embodiment, if at least one data of the second data set 120 does not fall within the tolerance interval around the nominal profile, i.e., if at least one data is considered non-compliant, the part 12 is subjected to a new iteration of steps 116 and 118 in order to subject it to a second deformation process, if this is deemed necessary and is authorized on the part reference.

Preferably, the algorithm 82 limits the deformations of the part 12 to a single deflection operation and a single untwisting operation.

In one embodiment, the algorithm 82 is configured to bring the part into compliance as and when required. In another embodiment, program 82 is configured to tend towards the nominal profile.

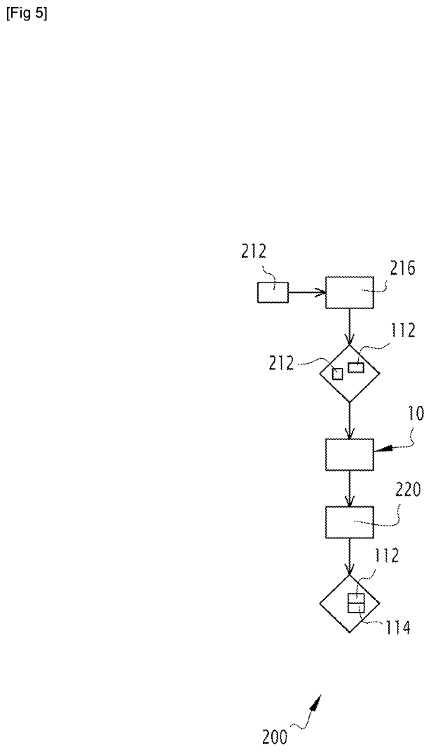

According to an embodiment, the self-learning algorithm 82, implemented in step 116, is developed at the end of a learning phase 200 as follows (FIG. 5):

A test batch of parts 212 in the initial condition is supplied. The parts 212 are similar to the production batch parts 12 described above. For example, each test batch comprises at least one hundred parts, and ideally at least four hundred parts. Each part 212 in the test batch undergoes the following steps:

The identifier 104 of the part 212 and the nominal definition 112 of said part are stored in the data memory 96 of the control device 94.

The first three-dimensional acquisition 216 of the part 212 is performed by the imaging device 91.

An operator then compares a profile of part 212 with the nominal definition 112 described above. Based on this comparison, the operator evaluates a suitable operation, chosen from the deflection and untwisting operations described above, to perform on the part 212 to deform it.

The operator then subjects said part 212 to the appropriate operation using the installation 10, controlling the gripping 32, support 34, bending 36 and torsion 38 units of said system. The geometrical data of the blade in the initial configuration, the positions, displacements, forces and torques previously described, measured by the sensors of the installation 10, as well as the conformity characteristics of the geometrical data are stored in the data memory 96.

Then, a second three-dimensional acquisition 220 of the part 212 thus deformed is performed by the imaging device 91.

The geometric data of the deformed blade—generated by the second three-dimensional acquisition 220—is compared with the nominal definition 112. The comparison determines whether the identified part 212 has been deformed so that it falls within the tolerance interval 114 around the blade's nominal profile.

These operations are repeated on a plurality of test batch 212 parts. A correlation analysis is carried out between the geometric measurements of each initial part and the geometric measurements of each deformed part in comparison with the theoretical profile, to determine the influential parameters for straightening the vanes corresponding to a nominal vane reference. The self-learning algorithm 82 is then developed, based on the influential parameters determined by the correlation analysis. The algorithm 82 is then stored in the program memory 98.

During the implementation of process 100 on the parts 12 of the production batch, the information stored in the memory 96 enables the said algorithm to be driven by machine learning, as indicated above, to improve the recommendations for torque/angle and force/travel values to be imparted to each part 12 to make it conform, with sufficient probability, to the nominal geometric profile.

In another embodiment, the learning phase 200 can be performed without human intervention, whereby the self-learning algorithm 82 can follow a predefined test plan, or a test plan with predefined limits, with the algorithm building the test plan within these limits.

1. A process for shaping a part of equipment of the turbine or compressor type vane, the shaping process comprising the following steps:
providing a part comprising a blade in an initial shape, said blade extending along an axis, and comprising at least one first gripping area located at one axial end of the blade;
providing a nominal definition representing the part in a nominal shape, said nominal definition comprising a set of nominal dimensions and associated tolerances;
acquiring in three dimensions a first set of data representing the part in the initial shape;
comparing the first set of data with the nominal definition to determine a compliance or non-compliance of at least one data item in the first data set;
for non-compliant data, determining by a self-learning algorithm, trained on a plurality of parts of the same type, of the appropriate force to apply to said part at a sufficient probability so that the non-compliant data at least is subsequently determined to be compliant;
applying the force determined in the previous step to the part to obtain a deformed shape,
acquiring in three dimensions a second data set representing the part in the deformed shape;
comparing the second set of data with the nominal definition to determine the compliance or non-compliance of one or more data items in the second data set;
measuring and recording the parameters of the first force applied, the first and second data sets, and the compliance and non-compliance characteristics determined in the comparison steps; and
training the self-learning algorithm based on the measurements and recordings taken in the previous step.

2. The process according to claim 1, in which the force is chosen between: a bending force, perpendicular to the blade axis; a torsional force about said blade axis; and a combined bending and torsional force.

3. The process according to claim 1, in which at least one three-dimensional acquisition is performed using contact or non-contact measuring equipment.

4. A process according to claim 3, wherein each of the nominal definition, the first and the second set of data comprises at least one data item from among: a set of dimensions of a section of the blade, a twist angle, a thickness of a leading edge of the blade, a thickness of a trailing edge of the blade, a position of a key point on an outer surface of the part, or a combination of any of these data items.

5. The process according to claim 1, in which, during the application of force to the blade, a grip is exerted on at least the first gripping area.

6. The process according to claim 1 in which, during the application of force to the blade, a second gripping area of the part is held stationary relative to a frame;

7. The process according to claim 6 in which the force is a bending force, perpendicular to the axis of the blade; said bending force being applied by exerting pressure on a bearing area of the blade, said bearing area being located between the first and second gripping areas of said part.

8. The process according to claim 6 in which: the force is a torsional force applied around the axis of the blade; one of the gripping elements and the second portion of the part is held stationary relative to a frame; and the torsional force is applied by rotating, relative to the frame, the other of said first and second gripping areas.

9. The process according to claim 6 in which: the force is a torsional force applied around the axis of the blade; and the torsional force is applied by rotating the first and second gripping areas relative to each other.

10. The process according to claim 1 wherein the part further comprises an identifier, the process additionally comprising the following steps: reading the identifier; determining the nominal definition corresponding to the part from a plurality of nominal definitions; and identifying the self-learning algorithm corresponding to part from a plurality of self-learning algorithms.

11. Assembly for implementing a process according to claim 1, comprising:
a measuring device, capable of acquiring three-dimensional data of the part, in the initial shape and/or in the deformed shape;
an installation capable of applying force to the part; and
an electronic device comprising a data memory and at least one self-learning algorithm trained on a plurality of parts of the same type as the part, said measuring device, the installation and the electronic device being linked by at least one communication channel.
